(19) United States
(12) Patent Application Publication
(10) Pub. No.: US 2011/0221865 A1
(43) Pub. Date: Sep. 15, 2011

(54) Method and Apparatus for Providing a Video Representation of a Three Dimensional Computer-Generated Virtual Environment

(75) Inventor: Arn Hyndman, Ottawa (CA)

(73) Assignee: Nortel Networks Limited, St. Laurent (CA)

(21) Appl. No.: 13/110,970

(22) Filed: May 19, 2011

Related U.S. Application Data
(63) Continuation of application No. PCT/CA2009/001725, filed on Nov. 27, 2009.
(60) Provisional application No. 61/118,683, filed on Dec. 1, 2008.

(51) Int. Cl. H04N 13/00

(52) U.S. Cl. 348/43; 348/E13.001

(57) ABSTRACT

A server process renders instances of a 3D virtual environment as video streams that may then be viewed on devices not sufficiently powerful to implement the rendering process natively or which do not have native rendering software installed. The server process is broken down into two steps: 3D rendering and video encoding. The 3D rendering step uses knowledge of the codec, target video frame rate, size, and bit rate from the video encoding step to render a version of the virtual environment at the correct frame rate, in the correct size, color space, and with the correct level of detail, so that the rendered virtual environment is optimized for encoding by the video encoding step. Likewise, the video encoding step uses knowledge of motion from the 3D rendering step in connection with motion estimation, macroblock size estimation, and frame type selection, to reduce the complexity of the video encoding process.

### CROSS-REFERENCE TO RELATED APPLICATIONS

This application is a continuation of PCT Application No. PCT/CA2009/001725, filed Nov. 27, 2009, which claims priority to U.S. Provisional Patent Application No. 61/118,683, filed Dec. 1, 2008, entitled “Video Bridge for Virtual Worlds”, the content of each of which is hereby incorporated herein by reference.

### BACKGROUND OF THE INVENTION

1. Field of the Invention

The present invention relates to virtual environments and, more particularly, to a method and apparatus for providing a video representation of a three dimensional computer-generated virtual environment.

2. Description of the Related Art

Virtual environments simulate actual or fantasy 3-D environments and allow for many participants to interact with each other and with constructs in the environment via remotely-located clients. One context in which a virtual environment may be used is in connection with gaming, where a user assumes the role of a character and takes control over most of that character's actions in the game. In addition to games, virtual environments are also being used to simulate real life environments to provide an interface for users that will enable on-line education, training, shopping, and other types of interactions between groups of users and between businesses and users.

In a virtual environment, an actual or fantasy universe is simulated within a computer processor/memory. Generally, a virtual environment will have its own distinct three dimensional coordinate space. Avatars representing users may move within the three dimensional coordinate space and interact with objects and other Avatars within the three dimensional coordinate space. The virtual environment server maintains the virtual environment and generates a visual presentation for each user based on the location of the user's Avatar within the virtual environment.

A virtual environment may be implemented as a stand-alone application, such as a computer aided design package or a computer game. Alternatively, the virtual environment may be implemented on-line so that multiple people may participate in the virtual environment through a computer network such as a local area network or a wide area network such as the Internet.

Users are represented in a virtual environment by an “Avatar” which is often a three-dimensional representation of a person or other object to represent them in the virtual environment. Participants interact with the virtual environment software to control how their Avatars move within the virtual environment. The participant may control the Avatar using conventional input devices, such as a computer mouse and keyboard, keypad, or optionally may use more specialized controls such as a gaming controller.

As the Avatar moves within the virtual environment, the view experienced by the user changes according to the user's location in the virtual environment (i.e. where the Avatar is located within the virtual environment) and the direction of view in the virtual environment (i.e. where the Avatar is looking) The three dimensional virtual environment is rendered based on the Avatar's position and view into the virtual environment, and a visual representation of the three dimensional virtual environment is displayed to the user on the user's display. The views are displayed to the participant so that the participant controlling the Avatar may see what the Avatar is seeing. Additionally, many virtual environments enable the participant to toggle to a different point of view, such as from a vantage point outside (i.e. behind) the Avatar, to see where the Avatar is in the virtual environment. An Avatar may be allowed to walk, run, swim, and move in other ways within the virtual environment. The Avatar may also be able to perform fine motor skills such as be allowed to pick up an object, throw an object, use a key to open a door, and perform other similar tasks.

Movement within a virtual environment or movement of an object through the virtual environment is implemented by rending the virtual environment in slightly different positions over time. By showing different iterations of the three dimensional virtual environment sufficiently rapidly, such as at 30 or 60 times per second, movement within the virtual environment or movement of an object within the virtual environment may appear to be continuous.

Generation of a fully immersive full motion 3D environment requires significant graphics processing capabilities, either in the form of graphics accelerator hardware or a powerful CPU. Additionally, rendering full motion 3D graphics also requires software that can access the processor and hardware acceleration resources of the device. In some situations it is inconvenient to deliver software that has these capabilities (i.e. users browsing the web must install some kind of software to allow 3D environments to be displayed, which is a barrier to use). And in some situations users may not be permitted to install new software on their device (mobile devices are frequently locked down as are some PCs in particularly security oriented organizations). Likewise, not all devices have graphics hardware or sufficient processing power to render full motion three dimensional virtual environment. For example, many home and laptop computers, as well as most conventional personal data assistants, cellular telephones, and other handheld consumer electronic devices, lack sufficient computing power to generate full motion 3D graphics. Since these limitations prevent people from using these types of devices to participate in the virtual environment, it would be advantageous to provide a way to enable these users to participate in three dimensional virtual environments using these types of limited capability computing devices.

### SUMMARY OF THE INVENTION

The following Summary and the Abstract set forth at the end of this application are provided herein to introduce some concepts discussed in the Detailed Description below. The Summary and Abstract sections are not comprehensive and are not intended to delineate the scope of protectable subject matter which is set forth by the claims presented below.

A server process renders instances of a 3D virtual environment as video streams that may then be viewed on devices not sufficiently powerful to implement the rendering process natively or which do not have native rendering software installed. The server process is broken down into two steps: 3D rendering and video encoding. The 3D rendering step uses knowledge of the codec, target video frame rate, size, and bit rate from the video encoding step to render a version of the virtual environment at the correct frame rate, in the correct size, color space, and with the correct level of detail, so that the rendered virtual environment is optimized for encoding by the video encoding step. Likewise, the video encoding step uses knowledge of motion from the 3D rendering step in connection with motion estimation, macroblock size estimation, and frame type selection, to reduce the complexity of the video encoding process.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example system enabling users to have access to three dimensional computer-generated virtual environment according to an embodiment of the invention;

FIG. 2 shows an example of a hand-held limited capability computing device;

FIG. 3 is a functional block diagram of an example rendering server according to an embodiment of the invention; and

FIG. 4 is a flow chart of a 3D virtual environment rendering and video encoding process according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

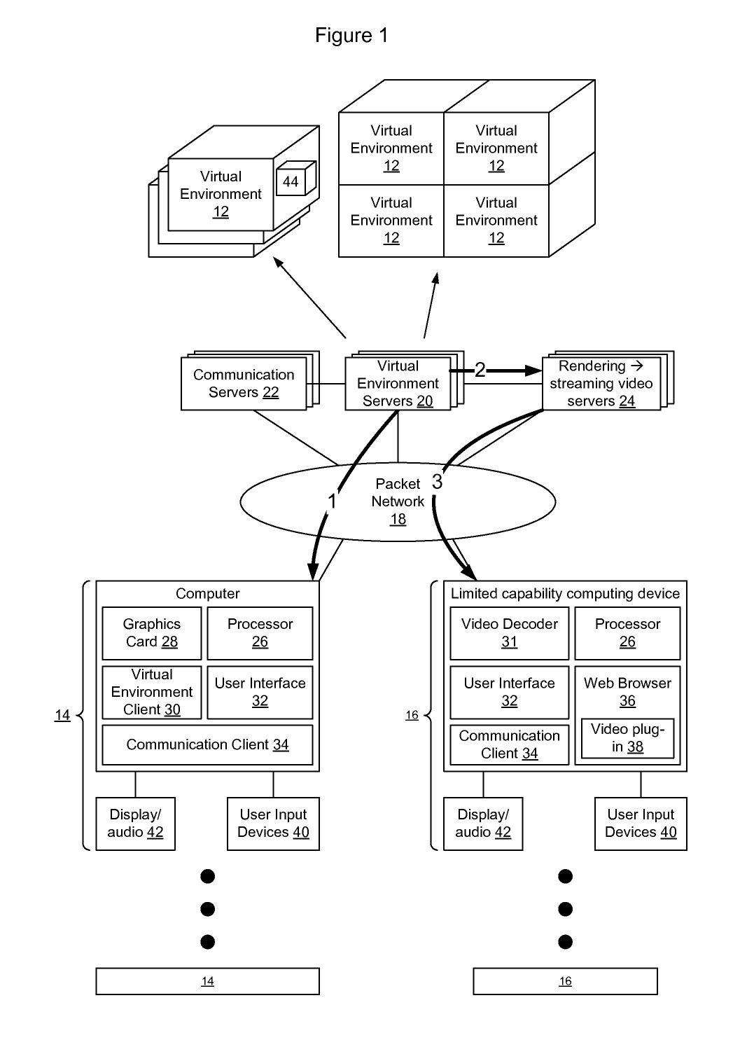

FIG. 1 shows a portion of an example system 10 showing the interaction between a plurality of users and one or more network-based virtual environments 12. A user may access the network-based virtual environment 12 using a computer 14 with sufficient hardware processing capability and required software to render a full motion 3D virtual environment. Users may access the virtual environment over a packet network 18 or other common communication infrastructure.

Alternatively, the user may desire to access the network-based virtual environment 12 using a limited capability computing device 16 with insufficient hardware/software to render a full motion 3D virtual environment. Example limited capability computing devices may include lower power laptop computers, personal data assistants, cellular phones, portable gaming devices, and other devices that either have insufficient processing capabilities to render full motion 3D virtual environment, or which have sufficient processing capabilities but lack the requisite software to do so. The term “limited capability computing device” will be used herein to refer to any device that either does not have sufficient processing power to render full motion 3D virtual environment, or which does not have the correct software to render full motion 3D virtual environment.

The virtual environment 12 is implemented on the network by one or more virtual environment servers 20. The virtual environment server maintains the virtual environment and enables users of the virtual environment to interact with the virtual environment and with each other over the network. Communication sessions such as audio calls between the users may be implemented by one or more communication servers 22 so that users can talk with each other and hear additional audio input while engaged in the virtual environment.

One or more rendering servers 24 are provided to enable users with limited capability computing devices to access the virtual environment. The rendering servers 24 implement rendering processes for each of the limited capability computing devices 16 and convert the rendered 3D virtual environment to video to be streamed to the limited capability computing device over the network 18. A limited capability computing device may have insufficient processing capabilities and/or installed software to render full motion 3D virtual environment, but may have ample computing power to decode and display full motion video. Thus, the rendering servers provide a video bridge that enables users with limited capability computing devices to experience full motion 3D virtual environments.

Additionally, the rendering server 24 may create a video representation of the 3D virtual environment for archival purposes. In this embodiment, rather than streaming the video live to a limited capability computing device 16, the video stream is stored for later playback. Since the rendering to video encoding process is the same in both instances, an embodiment of the invention will be described with a focus on creation of streaming video. The same process may be used to create video for storage however. Likewise, where a user of a computer 14 with sufficient processing power and installed software would like to record their interaction within the virtual environment, an instance of the combined 3D rendering and video encoding process may be implemented on computer 14 rather than server 24 to allow the user to record its actions within the virtual environment.

In the example shown in FIG. 1, the virtual environment server 20 provides input (arrow 1) to computer 14 in a normal manner to enable the computer 14 to render the virtual environment for the user. Where each computer user's view of the virtual environment is different, depending on the location and viewpoint of the user's Avatar, the input (arrow 1) will be unique for each user. Where the users are viewing the virtual environment through the same camera, however, the computers may each generate a similar view of the 3D virtual environment.

Likewise, the virtual environment server 20 also provides the same type of input (arrow 2) to the rendering servers 24 as is provided to the computers 14 (arrow 1). This allows the rendering server 24 to render a full motion 3D virtual environment for each of the limited capability computing device 16 being supported by the rendering server. The rendering server 24 implements a full motion 3D rendering process for each supported user and converts the user's output into streaming video. The streaming video is then streamed to the limited capability computing device over the network 18 so that the user may see the 3D virtual environment on their limited capability computing device.

There are other situations where the virtual environment supports a third person point of view from a set of fixed camera locations. For example, the virtual environment may have one fixed camera per room. In this case, the rendering server may render the virtual environment once for each fixed camera that is in use by at least one of the users, and then stream video associated with that camera to each user who is currently viewing the virtual environment via that camera. For example, in a presentation context each member of the audience may be provided with the same view of the presenter via a fixed camera in the auditorium. In this example and other such situations, the renderer server may render the 3D virtual environment once for the group of audience members, and the video encoding process may encode the video to be streamed to each of the audience members using the correct codec (e.g. correct video frame rate, bit rate, resolution, etc.) for that particular viewer. This allows the 3D virtual environment to be rendered once and video encoded multiple times to be streamed to the viewers. Note, in this context, that where the multiple viewers are configured to receive the same type of video stream, that the video encoding process is only required to encode the video once.

Where there are multiple viewers of a virtual environment, it is possible that the different viewers may wish to receive video at different frame and bit rates. For example, one group of viewers may be able to receive video at a relatively low bit rate and the other group of viewers may be able to receive video at a relatively high bit rate. Although all of the viewers will be looking into the 3D virtual environment via the same camera, different 3D rendering processes may be used to render the 3D virtual environment for each of the different video encoding rates if desired.

Computer 14 includes a processor 26 and optionally a graphics card 28. Computer 14 also includes a memory containing one or more computer programs which, when loaded into the processor, enable the computer to generate full motion 3D virtual environment. Where the computer includes a graphics card 28, part of the processing associated with generating the full motion 3D virtual environment may be implemented by the graphics card to reduce the burden on the processor 26.

In the example shown in FIG. 1, computer 14 includes a virtual environment client 30 which works in connection with the virtual environment server 20 to generate the three dimensional virtual environment for the user. A user interface 32 to the virtual environment enables input from the user to control aspects of the virtual environment. For example, the user interface may provide a dashboard of controls that the user may use to control his Avatar in the virtual environment and to control other aspects of the virtual environment. The user interface 32 may be part of the virtual environment client 30, or implemented as a separate process. A separate virtual environment client may be required for each virtual environment that the user would like to access, although a particular virtual environment client may be designed to interface with multiple virtual environment servers. A communication client 34 is provided to enable the user to communicate with other users who are also participating in the three dimensional computer-generated virtual environment. The communication client may be part of the virtual environment client 30, the user interface 32, or may be a separate process running on the computer 14. The user can control their Avatar within the virtual environment and other aspects of the virtual environment via user input devices 40. The view of the rendered virtual environment is presented to the user via display/audio 42.

The user may use control devices such as a computer keyboard and mouse to control the Avatar's motions within the virtual environment. Commonly, keys on the keyboard may be used to control the Avatar's movements and the mouse may be used to control the camera angle and direction of motion. One common set of letters that is frequently used to control an Avatar are the letters WASD, although other keys also generally are assigned particular tasks. The user may hold the W key, for example, to cause their Avatar to walk and use the mouse to control the direction in which the Avatar is walking Numerous other input devices have been developed, such as touch sensitive screens, dedicated game controllers, joy sticks, etc. Many different ways of controlling gaming environments and other types of virtual environments have been developed over time. Example input devices that have been developed including keypads, keyboards, light pens, mouse, game controllers, audio microphones, touch sensitive user input devices, and other types of input devices.

Limited capability computing device 16, like computer 14, includes a processor 26 and a memory containing one or more computer programs which, when loaded into the processor, enable the computer to participate in the 3D virtual environment. Unlike processor 26 of computer 14, however, the processor 26 in the limited capability computing device is either not sufficiently powerful to render a full motion 3D virtual environment or does not have access to the correct software that would enable it to render a full motion 3D virtual environment. Accordingly, to enable the user of limited capability computing device 16 to experience a full motion three dimensional virtual environment, the limited capability computing device 16 obtains streaming video representing the rendered three dimensional virtual environment from one of the rendering servers 24.

The limited capability computing device 16 may include several pieces of software depending on the particular embodiment to enable it to participate in the virtual environment. For example, the limited capability computing device 16 may include a virtual environment client similar to computer 14. The virtual environment client may be adapted to run on the more limited processing environment of the limited capability computing device. Alternatively, as shown in FIG. 1, the limited capability computing device 16 may have use a video decoder 31 instead of the virtual environment client 30. The video decoder 31 decodes streaming video representing the virtual environment, which was rendered and encoded by rendering server 24.

The limited capability computing device also includes a user interface to collect user input from the user and provide the user input to the rendering server 24 to enable the user to control the user's Avatar within the virtual environment and other features of the virtual environment. The user interface may provide the same dashboard as the user interface on computer 14 or may provide the user with a limited feature set based on the limited set of available controls on the limited capability computing device. The user provides user input via the user interface 32 and the particular user inputs are provided to the server that is performing the rendering for the user. The rendering server can provide those inputs as necessary to the virtual environment server where those inputs affect other users of the three dimensional virtual environment.

Alternatively, the limited capability computing device may implement a web browser 36 and video plug-in 38 to enable the limited capability computing device to display streaming video from the rendering server 24. The video plug-in enables video to be decoded and displayed by the limited capability computing device. In this embodiment, the web browser or plug-in may also function as the user interface. As with the computer 14, limited capability computing device 16 may include a communication client 34 to enable the user to talk with other users of the three dimensional virtual environment.

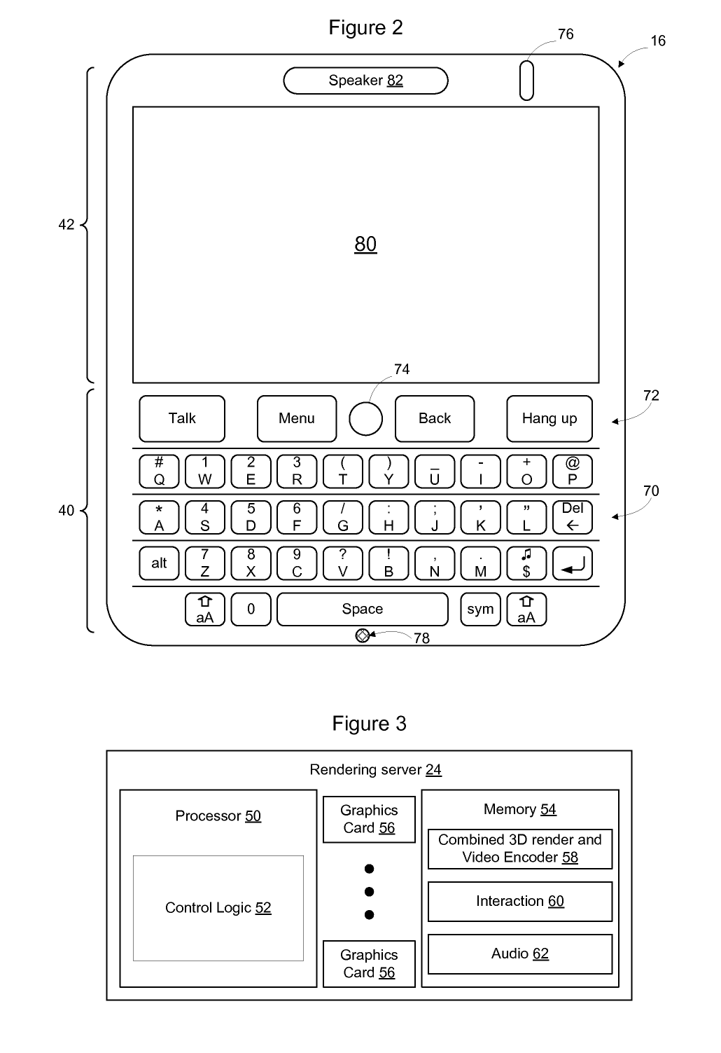

FIG. 2 shows one example of a limited capability computing device 16. As shown in FIG. 2, common handheld devices generally include user input devices 40 such as a keypad/keyboard 70, special function buttons 72, trackball 74, camera 76, and microphone 78. Additionally, devices of this nature generally have a color LCD display 80 and a speaker 82. The limited capability computing device 16 is also equipped with processing circuitry, e.g. a processor, hardware, and antenna, to enable the limited capability computing device to communicate on one or more wireless communication networks (e.g. cellular or 802.11 networks), as well as to run particular applications. Many types of limited capability computing devices have been developed and FIG. 2 is merely intended to show an example of a typical limited capability computing device.

As shown in FIG. 2, the limited capability computing device may have limited controls, which may limit the type of input a user can provide to a user interface to control actions of their Avatar within the virtual environment and to control other aspects of the virtual environment. Accordingly, the user interface may be adapted to enable different controls on different devices to be used to control the same functions within the virtual environment.

In operation, virtual environment server 20 will provide the rendering server 24 with information about the virtual environment to enable the rendering servers to render virtual environments for each of the limited capability computing devices. The rendering server 24 will implement a virtual environment client 30 on behalf of the limited capability computing devices 16 being supported by the server to render virtual environments for the limited capability computing devices. Users of the limited capability computing devices interact with user input devices 40 to control their avatar in the virtual environment. The inputs that are receive via the user input devices 40 are captured by the user interface 32, virtual environment client 30, or web browser, and passed back to the rendering server 24. The rendering server 24 uses the input in a manner similar to how virtual environment client 30 on computer 14 would use the inputs so that the user may control their avatar within the virtual environment. The rendering server 24 renders the three dimensional virtual environment, creates streaming video, and streams the video back to the limited capability computing device. The video is presented to the user on display/audio 42 so that the user can participate in the three dimensional virtual environment.

FIG. 3 shows a functional block diagram of an example rendering server 24. In the embodiment shown in FIG. 3, the rendering server 24 includes a processor 50 containing control logic 52 which, when loaded with software from memory 54, causes the rendering server to render three dimensional virtual environments for limited capability computing device clients, convert the rendered three dimensional virtual environment to streaming video, and output the streaming video. One or more graphics cards 56 may be included in the server 24 to handle particular aspects of the rendering processes. In some implementations virtually the entire 3D rendering and video encoding processes, from 3D to video encoding, can be accomplished on a modern programmable graphics card. In the near future GPUs (graphics processing units) may be the ideal platform to run the combined rendering and encoding processes.

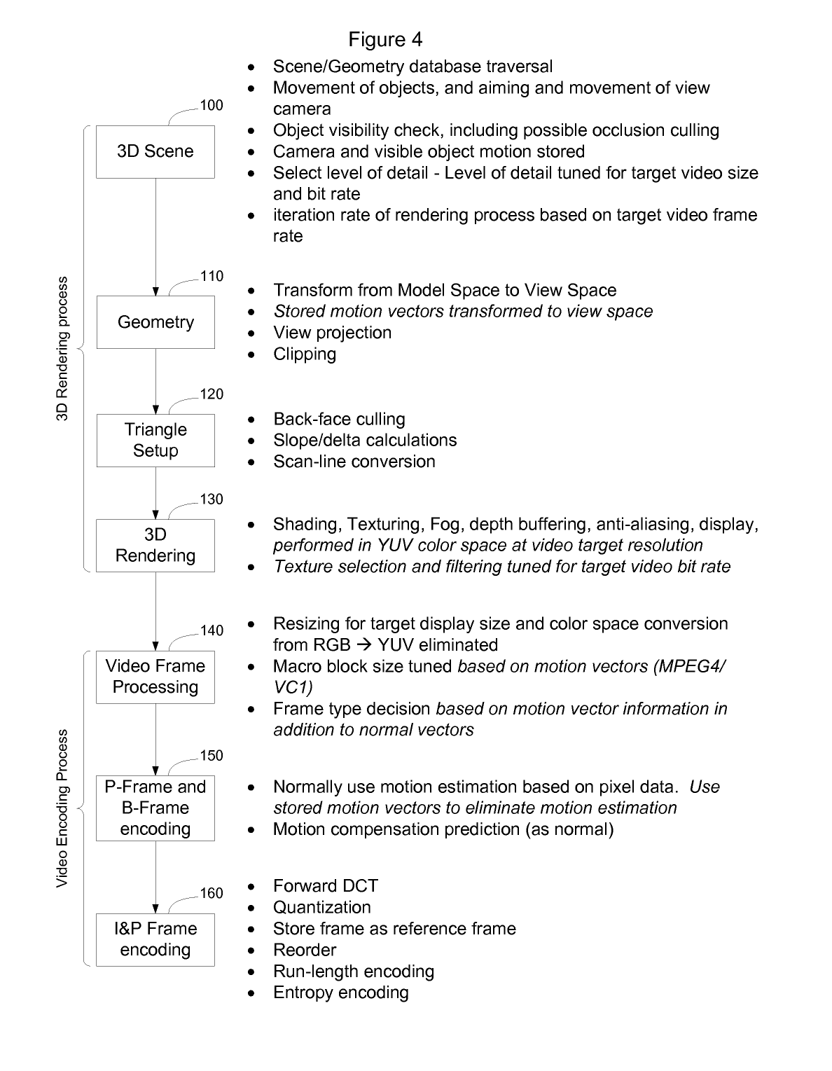

In the illustrated embodiment, the rendering server includes a combined three dimensional renderer and video encoder 58. The combined three dimensional renderer and video encoder operates as a three dimensional virtual environment rending process on behalf of the limited capability computing device to render a three dimensional representation of the virtual environment on behalf of the limited capability computing device. This 3D rendering process shares information with a video encoder process so that the 3D rendering process may be used to influence the video encoding process, and so that the video encoding process can influence the 3D rendering process. Additional details about the operation of the combined three dimensional rendering and video encoding process 58 are set forth below in connection with FIG. 4.

The rendering server 24 also includes interaction software 60 to receive input from users of the limited capability computing devices so that the users can control their avatars within the virtual environment. Optionally, the rendering server 24 may include additional components as well. For example, in FIG. 3 the rendering server 24 includes an audio component 62 that enables the server to implement audio mixing on behalf of the limited capability computing devices as well. Thus, in this embodiment, the rendering server is operating as a communication server 22 as well as to implement rendering on behalf of its clients. The invention is not limited to an embodiment of this nature, however, as multiple functions may be implemented by a single set of servers or the different functions may be split out and implemented by separate groups of servers as shown in FIG. 1.

FIG. 4 shows a combined 3D rendering and video encoding process that may be implemented by a rendering server 24 according to an embodiment of the invention. Likewise, the combined 3D rendering and video encoding process may be implemented by the rendering server 24 or by a computer 14 to record the user's activities within the 3D virtual environment.

As shown in FIG. 4, when a three dimensional virtual environment is to be rendered for display and then encoded into video for transmission over a network, the combined 3D rendering and video encoding process will logically proceed through several distinct phases (numbered 100-160 in FIG. 4). In practice, functionality of the different phases may be swapped or occur in different order depending on the particular embodiment. Additionally, different implementations may view the rendering and encoding processes somewhat differently and thus may have other ways of describing the manner in which a three dimensional virtual environment is rendered and then encoded for storage or transmission to a viewer.

In FIG. 4, the first phase of the 3D rendering and video encoding process is to create a model view of the three dimensional virtual environment (100). To do this, the 3D rendering process initially creates an initial model of the virtual environment, and in subsequent iterations traverses the scene/geometry data to look for movement of objects and other changes that may have been made to the three dimensional model. The 3D rendering process will also look at the aiming and movement of the view camera to determine a point of view within the three dimensional model. Knowing the location and orientation of the camera allows the 3D rendering process to perform an object visibility check to determine which objects are occluded by other features of the three dimensional model.

According to an embodiment of the invention, the camera movement or location and aiming direction, as well as the visible object motion will be stored for use by the video encoding process (discussed below), so that this information may be used instead of motion estimation during the video encoding phase. Specifically, since the 3D rendering process knows what objects are moving and knows what motion is being created, this information may be used instead of motion estimation, or as a guide to motion estimation, to simplify the motion estimation portion of the video encoding process. Thus, information available from the 3D rendering process may be used to facilitate video encoding.

Additionally, because the video encoding process is being done in connection with the three dimensional rendering process, information from the video encoding process can be used to select how the virtual environment client renders the virtual environment so that the rendered virtual environment is set up to be optimally encoded by the video encoding process. For example, the 3D rendering process will initially select a level of detail to be included in the model view of the three dimensional virtual environment. The level of detail affects how much detail is added to features of the virtual environment. For example, a brick wall that is very close to the viewer may be textured to show individual bricks interspaced by grey mortar lines. The same brick wall, when viewed from a larger distance, may be simply colored a solid red color.

Likewise, particular distant objects may be deemed to be too small to be included in the model view of the virtual environment. As the person moves through the virtual environment these objects will pop into the screen as the Avatar gets close enough for them to be included within the model view. Selection of the level of detail to be included in the model view occurs early in the process to eliminate objects that ultimately will be too small to be included in the final rendered scene, so that the rendering process is not required to expend resources modeling those objects. This enables the rendering process to be tuned to avoid wasting resources modeling objects representing items that will ultimately be too small to be seen, given the limited resolution of the streaming video.

According to an embodiment of the invention, since the 3D rendering process is able to learn the intended target video size and bit rate that will be used by the video encoding process to transmit video to the limited capability computing device, the target video size and bit rate may be used to set the level of detail while creating the initial model view. For example, if the video encoding process knows that the video will be streamed to a mobile device using 320×240 pixel resolution video, then this intended video resolution level may be provided to the 3D rendering process to enable the 3D rendering process to turn down the level of detail so that the 3D rendering process does not render a very detailed model view only to later have all the detail stripped out by the video encoding process. By contrast, if the video encoding process knows that the video will be streamed to a high-power PC using 960×540 pixel resolution video, then the rendering process may select a much higher level of detail.

The bit rate also affects the level of detail that may be provided to a viewer. Specifically, at low bit rates the fine details of the video stream begin to smear at the viewer, which limits the amount of detail that is able to be included in the video stream output from the video encoding process. Accordingly, knowing the target bit rate can help the 3D rendering process select a level of detail that will result creation of a model view that has sufficient detail, but not excessive detail, given the ultimate bit rate that will be used to transmit the video to the viewer. In addition to selecting objects for inclusion in the 3D model, the level of detail is tuned by adjusting the texture resolution (selecting lower resolution MIP maps) to an appropriate value for the video resolution and bit rate.

After creating a 3D model view of the virtual environment, the 3D rendering process will proceed to the geometry phase (110) during which the model view is transformed from the model space to view space. During this phase, the model view of the three dimensional virtual environment is transformed based on the camera and visual object views so that the view projection may be calculated and clipped as necessary. This results in translation of the 3D model of the virtual environment to a two-dimensional snapshot based on the vantage point of the camera at the particular point in time, which will be shown on the user's display.

The rendering process may occur many times per second to simulate full motion movement of the 3D virtual environment. According to an embodiment of the invention, the video frame rate used by the codec to stream video to the viewer is passed to the rendering process, so that the rendering process may render at the same frame rate as the video encoder. For example, if the video encoding process is operating at 24 frames per second (fps), then this frame encoding rate may be passed to the rendering process to cause the rendering process to render at 24 fps. Likewise, if the frame encoding process is encoding video at 60 fps, then the rendering process should render at 60 fps. Additionally, by rendering at the same frame rate as the encoding rate, it is possible to avoid jitter and/or extra processing to do frame interpolation which may occur when there is a mismatch between the rendering rate and the frame encoding rate.

According to an embodiment, the motion vectors and camera view information that was stored while creating the model view of the virtual environment are also transformed into view space. Transforming the motion vectors from model space to view space enables the motion vectors to be used by the video encoding process as a proxy for motion detection as discussed in greater detail below. For example, if there is an object moving in a three dimensional space, the motion of this object will need to be translated to show how the motion appears from the camera's view. Stated differently, movement of the object in three dimensional virtual environment space must be translated into two dimensional space as it will appear on the user's display. The motion vectors are similarly translated so that they correspond to the motion of objects on the screen, so that the motion vectors may be used instead of motion estimation by the video encoding process.

Once the geometry has been established, the 3D rendering process will create triangles (120) to represent the surfaces of virtual environment. 3D rendering processes commonly only render triangles, such that all surfaces on the three dimensional virtual environment are tessellated to create triangles, and those triangles that are not visible from the camera viewpoint are culled. During the triangle creation phase, the 3D rendering process will create a list of triangles that should be rendered. Normal operations such as slope/delta calculations and scan-line conversion are implemented during this phase.

The 3D rendering process then renders the triangles (130) to create the image that is shown on the display 42. Rendering of the triangles generally involves shading the triangles, adding texture, fog, and other effects, such as depth buffering and anti-aliasing. The triangles will then be displayed as normal.

Three dimensional virtual environment rendering processes render in Red Green Blue (RGB) color space, since that is the color space used by computer monitors to display data. However, since the rendered three dimensional virtual environment will be encoded into streaming video by a video encoding process, rather than rendering the virtual environment in RGB color space, the 3D rendering process of the rendering server instead renders the virtual environment in YUV color space. YUV color space includes one luminance component (Y) and two color components (U and V). Video encoding processes generally convert RGB color video to YUV color space prior to encoding. By rendering in YUV color space rather than RGB color space, this conversion process may be eliminated to improve the performance of the video encoding process.

Additionally, according to an embodiment of the invention, the texture selection and filtering processes are tuned for the target video and bit rate. As noted above, one of the processes that is performed during the rendering phase (130) is to apply texture to the triangles. The texture is the actual appearance of the surface of the triangle. Thus, for example, to render a triangle which is supposed to look like a part of a brick wall, a brick wall texture will be applied to the triangle. The texture will be applied to the surface and skewed based on the vantage point of the camera so to provide a consistent three dimensional view.

During the texturing process it is possible for the texture to blur, depending on the particular angle of the triangle relative to the camera vantage point. For example, a brick texture applied to a triangle that is drawn at a very oblique angle within the view of the 3D virtual environment may be very blurred due to the orientation of the triangle within the scene. Hence, the texture for particular surfaces may be adjusted to use a different MIP so that the level of detail for the triangle is adjusted to eliminate complexity that a viewer is unlikely to be able to see anyway. According to an embodiment, the texture resolution (selection of the appropriate MIP) and texture filter algorithm are affected by the target video encoding resolution and bit rate. This is similar to the level of detail tuning discussed above in connection with the initial 3D scene creation phase (100) but is applied on a per-triangle basis to enable the rendered triangles to be individually created with a level of detail that will be visually apparent once encoded into streaming video by the video encoding process.

Rendering of the triangles completes the rendering process. Normally, at this point, the three dimensional virtual environment would be shown to the user on the user's display. For video archival purposes or for limited capability computing devices, however, this rendered three dimensional virtual environment will be encoded into streaming video for transmission by the video encoding process. Many different video encoding processes have been developed over time, although currently the higher performance video encoding processes typically encode video by looking for motion of objects within the scene rather than simply transmitting pixel data to completely re-draw the scene at each frame. In the following discussion, an MPEG video encoding process will be described. The invention is not limited to this particular embodiment as other types of video encoding processes may be used as well. As shown in FIG. 4, an MPEG video encoding process generally includes video frame processing (140), P (predictive) & B (bi-directional predictive) frame encoding (150), and I (Intracoded) frame encoding (160). I-frames are compressed but do not depend on other frames to be decompressed.

Normally, during video frame processing (140), the video processor would resize the image of the three dimensional virtual environment rendered by the 3D rendering process for the target video size and bit rate. However, since the target video size and bit rate were used by the 3D rendering process to render the three dimensional virtual environment at the correct size and with the level of detail tuned for the target bit rate, the video encoder may skip this process. Likewise, the video encoder would normally also perform color space conversion to convert from RGB to YUV to prepare to have the rendered virtual environment encoded as streaming video. However, as noted above, according to an embodiment of the invention the rendering process is configured to render in YUV color space so that this conversion process may be omitted by the video frame encoding process. Thus, by providing information from the video encoding process to the 3D rendering process, the 3D rendering process may be tuned to reduce the complexity of the video encoding process.

The video encoding process will also tune the macro block size used to encode the video based on the motion vectors and the type of encoding being implemented. MPEG2 operates on 8×8 arrays of pixels known as blocks. A 2×2 array of blocks is commonly referred to as a macroblock. Other types of encoding processes may use different macroblock sizes, and the size of the macroblock may also be adjusted based on the amount of motion occurring in the virtual environment. According to an embodiment, the macroblock size may be adjusted based on the motion vectors information so that the amount of motion occurring between frames, as determined from the motion vectors, may be used to influence the macroblock size used during the encoding process.

Additionally, during the video frame processing phase, the type of frame to be used to encode the macroblock is selected. In MPEG2, for example, there are several types of frames. I-Frames are encoded without prediction, P-Frames may be encoded with prediction from previous frames, and B-Frames (Bi-directional) frames may be encoded using prediction from both previous and subsequent frames.

In normal MPEG2 video encoding, data representing macroblocks of pixel values for a frame to be encoded are fed to both the subtractor and the motion estimator. The motion estimator compares each of these new macroblocks with macroblocks in a previously stored iteration. It finds the macroblock in the previous iteration that most closely matches the new macroblock. The motion estimator then calculates a motion vector which represents the horizontal and vertical movement from the macroblock being encoded to the matching macroblock-sized area in the previous iteration.

According to an embodiment of the invention, rather than using motion estimation based on pixel data, the stored motion vectors are used to determine the motion of objects within the frame. As noted above, the camera and visible object motion is stored during the 3D scene creation phase (100) and then transformed to view space during the geometry phase (110). These transformed motion vectors are used by the video encoding process to determine the motion of objects within the view. The motion vectors may be used instead of motion estimation or may be used to provide guidance in the motion estimation process during the video frame processing phase to simplify the video encoding process. For example, if the transformed motion vector indicates that a baseball has traveled 12 pixels to the left within the scene, the transformed motion vector may be used in the motion estimation process to start searching for a block of pixels 12 pixels to the left of where it initially was located in the previous frame. Alternatively, the transformed motion vector may be used instead of motion estimation to simply cause a block of pixels associated with the baseball to be translated 12 pixels to the left without requiring the video encoder to also do a pixel comparison to look for the block at that location.

In MPEG 2, the motion estimator also reads this matching macroblock (known as a predicted macroblock) out of the reference picture memory and sends it to the subtractor which subtracts it, on a pixel by pixel basis, from the new macroblock entering the encoder. This forms an error prediction or residual signal that represents the difference between the predicted macroblock and the actual macroblock being encoded. The residual is transformed from the spatial domain by a 2 dimensional Discrete Cosine Transform (DCT), which includes separable vertical and horizontal one-dimensional DCTs. The DCT coefficients of the residual then are quantized to reduce the number of bits needed to represent each coefficient.

The quantized DCT coefficients are Huffman run/level coded which further reduces the average number of bits per coefficient. The coded DCT coefficients of the error residual are combined with motion vector data and other side information (including an indication of I, P or B picture).

For the case of P frames, the quantized DCT coefficients also go to an internal loop that represents the operation of the decoder (a decoder within the encoder). The residual is inverse quantized and inverse DCT transformed. The predicted macroblock read out of the reference frame memory is added back to the residual on a pixel by pixel basis and stored back into memory to serve as a reference for predicting subsequent frames. The object is to have the data in the reference frame memory of the encoder match the data in the reference frame memory of the decoder. B frames are not stored as reference frames.

The encoding of I frames uses the same process, however no motion estimation occurs and the (−) input to the subtractor is forced to 0. In this case the quantized DCT coefficients represent transformed pixel values rather than residual values as was the case for P and B frames. As is the case for P frames, decoded I frames are stored as reference frames.

Although a description of a particular encoding process (MPEG 2) was provided, the invention is not limited to this particular embodiment as other encoding steps may be utilized depending on the embodiment. For example, MPEG 4 and VC-1 use similar but somewhat more advanced encoding process. These and other types of encoding processes may be used and the invention is not limited to an embodiment that uses this precise encoding process. As noted above, according to an embodiment of the invention, motion information about objects within the three dimensional virtual environment may be captured and used during the video encoding process to make the motion estimation process of the video encoding process more efficiently. The particular encoding process utilized in this regard will depend on the particular implementation, These motion vectors may also be used by the video encoding process to help determine the optimum block size to be used to encode the video, and the type of frame that should be used. In the other direction, since the 3D rendering process knows the target screen size and bit rate to be used by the video encoding process, the 3D rendering process may be tuned to render a view of the three dimensional virtual environment that is the correct size for the video encoding process, has the correct level of detail for the video encoding process, is rendered at the correct frame rate, and is rendered using the correct color space that the video encoding process will use to encode the data for transmission. Thus, both processes may be optimized by combining them into a single combined 3D renderer and video encoder 58 as shown in the embodiment of FIG. 3.

The functions described above may be implemented as one or more sets of program instructions that are stored in a computer readable memory within the network element(s) and executed on one or more processors within the network element(s). However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of creating a video representation of a three dimensional computer-generated virtual environment, the method comprising the steps of:
rendering, by a 3D rendering process, an iteration of a three dimensional virtual environment based on information from a video encoding process, the information from the video encoding process including an intended screen size and bit rate of a video representation of the rendered iteration of the three dimensional virtual environment to be created by the video encoding process.

2. The method of claim 1, wherein the information from the video encoding process includes a frame rate used by the video encoding process; and wherein the step of rendering is iterated by the 3D rendering process the frame rate so that a frequency at which the 3D rendering process renders iterations of the three dimensional virtual environment matches the frame rate used by the video encoding process.

3. The method of claim 1, wherein the step of rendering is implemented by the 3D rendering process in a color space used by the video encoding process to encode the video so that the video encoding process does not need to perform color conversion when creating the video representation of the rendered iteration of the three dimensional virtual environment.

4. The method of claim 3, wherein the step of rendering is implemented by the 3D rendering process in YUV color space and wherein the video encoding process encodes video in the YUV color space.

5. The method of claim 1, wherein the intended screen size and bit rate is used by the rendering process to select a level of detail for the rendered 3D virtual environment to be created by the 3D rendering process.

6. The method of claim 1, wherein the step of rendering comprises the steps of creating a 3D scene of the 3D virtual environment in 3D model space, transforming the 3D model space to view space; performing triangle setup; and rendering the triangles.

7. The method of claim 6, wherein the step of creating the 3D scene of the 3D virtual environment in 3D Model space comprises determining movement of objects within the virtual environment, determining movement of a camera location and orientation within the virtual environment, and storing vectors associated with movement of objects within the virtual environment and movement of the camera within the virtual environment.

8. The method of claim 7, wherein the step of transforming from the model space to view space comprises transforming the vectors from the 3D model space to view space, so that the vectors may be used by the video encoding process to perform motion estimation.

9. The method of claim 6, wherein the step of rendering the triangles uses the information from the video encoding process to perform texture selection and filtering for the triangles.

10. The method of claim 1, further comprising encoding, by the video encoding process, the iteration of the three dimensional virtual environment rendered by the rendering process to create the video representation of the rendered iteration of the three dimensional virtual environment.

11. The method of claim 10, wherein the video representation is streaming video.

12. The method of claim 10, wherein the video representation is video to be archived video.

13. The method of claim 10, wherein the video encoding process receives motion vector information from the 3D rendering process, and uses the motion vector information in connection with block motion detection.

14. The method of claim 13, wherein the motion vector information has been transformed from 3D model space to view space to correspond with motion of objects in a view of the rendered virtual environment to be encoded by the video encoding process.

15. The method of claim 13, wherein the video encoding process uses the motion vector information from the rendering process to perform block size selection.

16. The method of claim 13, wherein the video encoding process uses the motion vector information from the rendering process to perform frame type decisions for block encoding.

17. The method of claim 10, wherein the step of encoding comprises video frame processing, P and B-Frame encoding, and I&P Frame encoding.

18. The method of claim 17, wherein the step of P-Frame encoding comprises a step of searching to match a current block with a block of an earlier reference frame to determine how the current block has moved relative to the earlier reference frame, and wherein the video encoding process uses the motion vector information from the rendering process to the step of searching to cause the step of searching to be initiated at a location indicated by at least one of the motion vectors.

19. The method of claim 17, wherein the step of P-Frame encoding includes a step of performing motion estimation of a current block relative to a block of an earlier reference by referencing at least one of the motion vectors provided by the rendering process.

20. The method of claim 10, wherein the video encoding process is configured to omit the steps of resizing the rendered iteration of the three dimensional virtual environment, implementing color space conversion from the rendered iteration of the three dimensional virtual environment to a color space used by the video encoding process, and performing frame interpolation while performing the step of encoding the iteration of the three dimensional virtual environment.
